(19) United States
(12) Patent Application Publication
(10) Pub. No.: US 2026/0135103 A1
(43) Pub. Date: May 14, 2026

(54) BATTERY

(71) Applicant: TOYOTA JIDOSHA KABUSHIKI KAISHA, Toyota-shi (JP)

(72) Inventors: Ryo ASAKURA, Sunto-gun (JP); Shinya SHIOTANI, Nagoya-shi (JP); Shin USHIRODA, Susono-shi (JP)

(73) Assignee: TOYOTA JIDOSHA KABUSHIKI KAISHA, Toyota-shi (JP)

(21) Appl. No.: 19/180,395

(22) Filed: Apr. 16, 2025

(30) Foreign Application Priority Data
Jul. 31, 2024 (JP) 2024-124413

(51) Int. Cl. H01M 4/58; H01M 4/02; H01M 4/136; H01M 4/62; H01M 10/0585

(52) U.S. Cl. CPC H01M 4/5815; H01M 4/136; H01M 4/625; H01M 10/0585; H01M 2004/021; H01M 2004/028

(57) ABSTRACT

A battery includes an electrode body in which a positive electrode active material layer, an electrolyte layer, and a negative electrode active material layer are laminated, in which: the positive electrode active material layer contains a positive electrode active material and a carbon nanotube, the positive electrode active material containing an S element; and the specific surface area of the carbon nanotube in the positive electrode active material layer is 400 m²/g or more.

### CROSS-REFERENCE TO RELATED APPLICATION

This application claims priority to Japanese Patent Application No. 2024-124413 filed on Jul. 31, 2024. The disclosure of the above-identified application, including the specification, drawings, and claims, is incorporated by reference herein in its entirety.

### BACKGROUND

### 1. Technical Field

The present disclosure relates to a battery.

### 2. Description of Related Art

Japanese Unexamined Patent Application Publication No. 2019-212615 (JP 2019-212615 A) discloses an all-solid-state battery that contains S, P₂S₅, and a vapor-grown carbon fiber as a conduction aid.

Japanese Unexamined Patent Application Publication No. 2015-079623 (JP 2015-079623 A) discloses an all-solid “sodium ion battery” that includes a sulfur positive electrode, and in which the specific surface area of a positive electrode conduction aid is 1000 m²/g.

### SUMMARY

As a method for improving the energy density of a solid-state battery, there is a method of applying a sulfur(S) active material to a positive electrode. However, when the sulfur active material is used in the positive electrode, the discharge capacity and the cycle characteristic tend to decrease.

In response, a vapor-grown carbon fiber is sometimes contained as C in a positive electrode active material layer. However, the problems cannot be always sufficiently solved.

Hence, the present disclosure has an object to provide a battery that makes it possible to improve the battery performance in a battery containing a sulfur active material.

The present application discloses a battery including an electrode body in which a positive electrode active material layer, an electrolyte layer, and a negative electrode active material layer are laminated, in which: the positive electrode active material layer contains a positive electrode active material and a carbon nanotube, the positive electrode active material containing an S element; and the specific surface area of the carbon nanotube in the positive electrode active material layer is 400 m²/g or more.

The specific surface area of the carbon nanotube may be 1000 m²/g or more.

The positive electrode active material layer may contain a sulfur-containing compound that contains the S element and a P element.

The negative electrode active material layer may contain an Li metal.

The electrolyte layer may contain a solid electrolyte, and the battery may be an all-solid-state battery.

The battery in the present disclosure makes it possible to improve the battery performance, particularly, the discharge capacity and the cycle characteristic, in a battery containing a sulfur active material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for describing a layer configuration of a solid-state battery 10; and

FIG. 2 is a graph showing results of a test.

### DETAILED DESCRIPTION OF EMBODIMENTS

### 1. Configuration of Battery

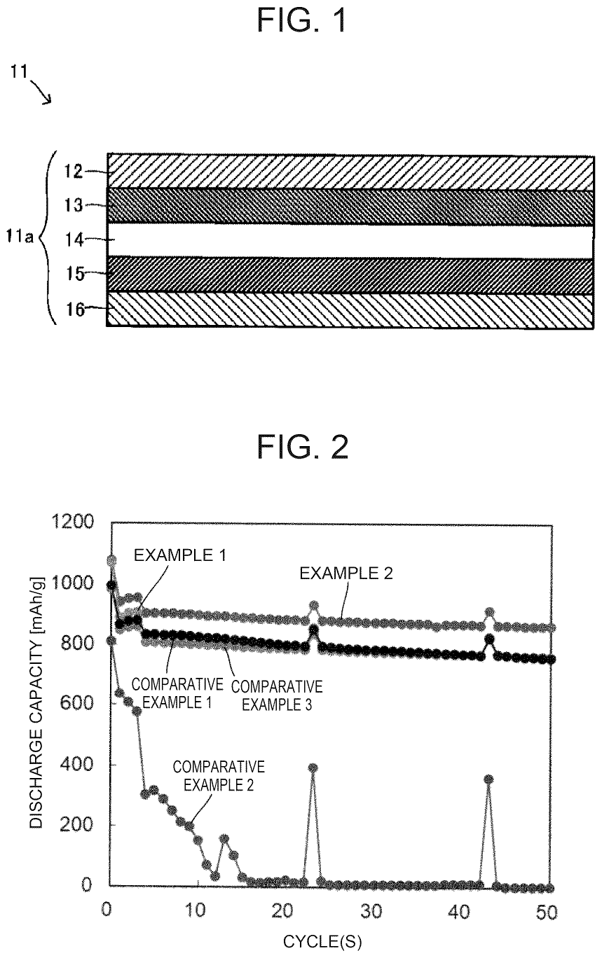

FIG. 1 shows a diagram for describing a solid-state battery (all-solid-state battery) according to an embodiment. Here, the all-solid-state battery will be described as a typical example. However, the present disclosure does not always need to be an all-solid-state battery, and can be applied to any battery (for example, a solid-state battery (semi-solid-state battery) including a solid electrolyte and an electrolytic solution) including an electrode body and an outer packaging body that encloses the electrode body in a sealed manner. FIG. 1 illustrates a layer configuration of an electrode body 11 that is included in the solid-state battery. Such an electrode body 11 is enclosed by an outer packaging body, and thereby, the solid-state battery is formed. For example, the electrode body 11 having a roughly rectangular shape in planar view is enveloped by the outer packaging body having a roughly rectangular shape in planar view. On this occasion, the electrode body 11 is disposed such that a positive electrode terminal extends from a positive electrode current collector of the electrode body 11, a negative electrode terminal extends from a negative electrode current collector of the electrode body 11, and distal ends of the positive electrode terminal and the negative electrode terminal project from the outer packaging body.

Constituents of the electrode body 11 and relations among the constituents will be described below in more detail.

The electrode body 11 includes a positive electrode current collector 12, a positive electrode active material layer 13, a solid electrolyte layer 14, a negative electrode active material layer 15, and a negative electrode current collector 16. In the embodiment, the positive electrode current collector 12, the positive electrode active material layer 13, the solid electrolyte layer 14, the negative electrode active material layer 15, and the negative electrode current collector 16 are laminated in this order, and constitute a unit element 11a. In the electrode body 11, a plurality of unit elements 11a is laminated (only one unit element 11a is shown in FIG. 1). Moreover, as described above, the positive electrode terminal is electrically connected to the positive electrode current collector 12 of the electrode body 11, and the negative electrode terminal is electrically connected to the negative electrode current collector 16 of the electrode body 11.

### 1.1. Positive Electrode Current Collector

The positive electrode current collector 12 is laminated on the positive electrode active material layer 13, and performs current collection from the positive electrode active material layer 13. In the embodiment, the positive electrode current collector 12 is a foil member that has a quadrangular shape in planar view, and can be constituted by a positive electrode current collecting foil that is a metal foil, and a conductive resin layer and carbon layer that is laminated on the positive electrode current collecting foil.

The carbon layer is laminated on the positive electrode active material layer 13, and thereby, the positive electrode current collector 12 is laminated on the positive electrode active material layer 13.

As materials that compose the positive electrode current collector, examples of the material of the metal foil include stainless steel, aluminum, nickel, iron, and titanium. The conductive resin layer can be composed of a resin in which a conductive material is dispersed, and the carbon layer can be composed of a material that contains carbon.

### 1.2. Positive Electrode Active Material Layer

On one surface of the positive electrode active material layer 13, the positive electrode current collector 12 is laminated, and on the other surface of the positive electrode active material layer 13, the solid electrolyte layer 14 is laminated. In the embodiment, the positive electrode active material layer 13 is a sheet member that has a quadrangular shape in planar view.

The positive electrode active material layer 13 contains a positive electrode active material containing the S element, and a conduction aid, and as necessary, contains a sulfur-containing compound that contains the P element and the S element.

### Positive Electrode Active Material

The positive electrode active material contains the S element. Preferably, the positive electrode active material should be an elemental sulfur. Examples of the elemental sulfur include S8 sulfur. As for the S8 sulfur, there are three crystal forms: an a sulfur (rhombic sulfur), a β sulfur (monoclinic sulfur), and a γ sulfur (monoclinic sulfur), and any crystal form may be adopted.

In the case where the elemental sulfur is contained as the positive electrode active material, a peak for the elemental sulfur, in the positive electrode active material layer, may be present, or may be absent in an XRD measurement. Typical peaks for the elemental sulfur appear at 2θ=23.05°±0.50°, 25.84°±0.50°, and 27.70°±0.50°, in an XRD measurement in which a CuKα ray was used. Each of the positions of the peaks may be in a range of ±0.30°, or may be in a range of ±0.10°.

Some or all of the elemental sulfur may be dissolved in a later-described sulfur-containing compound. In other words, the positive electrode active material layer may contain a solid solution of the elemental sulfur and the sulfur-containing compound. Further, a chemical bond (S—S bond) may be performed between the S element in the elemental sulfur and the S element in the sulfur-containing compound.

### Conduction Aid

The conduction aid has a function to improve the electron conductibility in the positive electrode active material layer. Further, the conduction aid is estimated to function also as a reductant that reduces the elemental sulfur when mechanical milling is performed to a raw material mixture, for example. It is preferable that the conduction aid exist so as to be dispersed in the positive electrode active material layer.

In the present disclosure, the conduction aid is a carbon nanotube (CNT). Moreover, the carbon nanotube is contained in the positive electrode active material layer such that a BET specific surface area is 400 m²/g or more, and furthermore, it is preferable that the BET specific surface area be 1000 m²/g or more.

The BET specific surface area is a specific surface area that is calculated by a BET method using the monomolecular adsorption amount of gas to a substance surface.

As the carbon nanotube, there are a multi-walled carbon nanotube and a single-walled carbon nanotube, and the single-walled carbon nanotube is preferable.

In this way, a carbon nanotube having a high specific surface area is used as the conduction aid in the positive electrode active material layer containing the S element. Thereby, electron conducting paths are amplified, and in addition, the self-formation of Li⁺ conducting paths is promoted, so the discharge capacity and the cycle characteristic are improved.

The content ratio of the carbon nanotube in the positive electrode active material layer is not particularly limited, as long as the carbon nanotube is contained so as to meet the above specific surface area. The content ratio of the carbon nanotube in the positive electrode active material layer preferably should be 5 mass % or more, more preferably should be 15 mass % or more, and further preferably should be 20 mass % or more.

### Sulfur-Containing Compound

As the sulfur-containing compound, the positive electrode active material layer may contain a sulfur-containing compound that contains the P element and the S element. The sulfur-containing compound may be constituted by only the sulfur-containing compound that contains the P element and the S element, or may be further contain a sulfur-containing compound that contains another element (for example, Ge, Sn, Si, B, or Al) and the S element. In the case of the latter, it is preferable that the sulfur-containing compound contain the sulfur-containing compound that contains the P element and the S element, as a main component of the sulfur-containing compound.

It is allowable to adopt a sulfur-containing compound that does not substantially contain the Li element. Further, it is preferable that the sulfur-containing compound serve as an ion conducting path at the time of charge and discharge. In the case where the sulfur-containing compound exists in the positive electrode active material layer, the ion conducting path in the positive electrode active material layer is secured by the sulfur-containing compound, even when the ion conductibility of a discharge product (for example, Li₂S) is low, and therefore, the discharge reaction proceeds easily.

It is preferable that the sulfur-containing compound contain an ortho structure with the P element. Specifically, the ortho structure with the P element is a PS₄ structure. Further, the sulfur-containing compound may contain an ortho structure with an M element (M is Ge, Sn, Si, B, or Al). Examples of the ortho structure with the M element include a GeS₄ structure, an SnS₄ structure, an SiS₄ structure, a BS₃ structure, and an AlS₃ structure. Moreover, the sulfur-containing compound may contain a sulfide (for example, P₂S₅) with the P element. Further, the sulfur-containing compound may contain a sulfide (MₓS_{y}) with the M element. Here, x and y are integers that give electric neutrality between M and S depending on the kind of M. Examples of the sulfide (MₓS_{y}) include GeS₂, SnS₂, SiS₂, B₂S₃, and Al₂S₃. Further, the sulfides are residual materials of starting materials, for example.

### Others

In the positive electrode active material layer, the mole ratio (P/S) of the P element to the S element is not particularly limited. The mole ratio (P/S) is 0.03 or more, for example, and may be 0.06 or more, may be 0.09 or more, or may be 0.12 or more. On the other hand, the mole ratio (P/S) is 0.5 or less, for example, and may be 0.3 or less, or may be 0.27 or less. The denominator of the mole ratio (P/S) means the total amount of the S element contained in the positive electrode active material layer. Both of the positive electrode active material and sulfur-containing compound in the embodiment contain the S element, and therefore, the S element amounts of the positive electrode active material and the sulfur-containing compound are summed.

The thickness of the positive electrode active material layer is 0.1 μm or more and 1000 μm or less, for example. Further, the weight of the positive electrode layer per unit area is more than 3 mg/cm², for example, and may be 4 mg/cm² or more, or may be 5 mg/cm² or more.

Further, it is allowable to adopt a positive electrode active material layer that does not substantially contain the Li element. Thereby, the decrease in capacity can be restrained.

The expression “does not substantially contain the Li element” means that the ratio of the Li element to all elements contained in the positive electrode active material layer is 20 mol % or less. The ratio of the Li element may be 16 mol % or less, may be 8 mol % or less, may be 4 mol % or less, or may be 0 mol %.

Further, it is allowable to adopt a positive electrode active material layer that does not substantially contain the Na element. The expression “does not substantially contain the Na element” means that the ratio of the Na element to all elements contained in the positive electrode active material layer is 20 mol % or less. The ratio of the Na element may be 16 mol % or less, may be 8 mol % or less, may be 4 mol % or less, or may be 0 mol %.

### 1.3. Solid Electrolyte Layer

The solid electrolyte layer 14 is a layer that is formed between the positive electrode active material layer and the negative electrode active material layer. Further, the solid electrolyte layer is a layer that contains at least a solid electrolyte layer, and may contain a binder as necessary.

Examples of the solid electrolyte include a sulfide solid electrolyte, an oxide solid electrolyte, a nitride solid electrolyte, and a halide solid electrolyte, and among them the sulfide solid electrolyte is preferable. It is preferable that the sulfide solid electrolyte contain the Li element, an A element (A is at least one kind of P, Ge, Si, Sn, B, and Al), and the S element. The sulfide solid electrolyte may further contain a halogen element. Examples of the halogen element include the F element, the Cl element, the Br element, and the I element. Further, the sulfide solid electrolyte may further contain the O element.

30 Examples of the sulfide solid electrolyte include Li₂S—P₂Ss, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (m and n are positive values, and Z is one of Ge, Zn, and Ga), Li₂S—GeS₂, Li₂S—SiS₂—Li₃PO₄, Li₂S—SiS₂—LiₓMO_{y} (x and y are positive values, and M is one of P, Si, Ge, B, Al, Ga, and In).

The ratio of the solid electrolyte contained in the solid electrolyte layer is 50 volume % or more, for example, and may be 70 volume % or more, or may be 90 volume % or more. The binder that is used in the solid electrolyte layer has the same contents as the contents described above for the negative electrode layer. Further, the thickness of the solid electrolyte layer is 0.1 μm or more and 1000 μm or less, for example,

### 1.4. Negative Electrode Active Material Layer

The negative electrode active material layer 15 is a layer that contains at least a negative electrode active material. It is preferable that the negative electrode active material contain the Li element. As such a negative electrode active material, there are an elemental lithium and a lithium alloy. Examples of the lithium alloy include an Li—X alloy. Here, X can include Mg, Ag, In, Sn, Si, Ga, Au, and Pt.

### 1.5. Negative Electrode Current Collector

The negative electrode current collector 16 is laminated on the negative electrode active material layer 15, and performs current collection from the negative electrode active material layer 15. In the embodiment, the negative electrode current collector 16 is a foil member that has a quadrangular shape in planar view, and can be composed of stainless steel, copper, nickel, carbon, or aluminum, for example.

### 1.6. Positive Electrode Terminal, Negative Electrode Terminal

The positive electrode terminal and the negative electrode terminal are members that have electric conductivity, and are terminals for electrically connecting the respective electrodes to the exterior.

A first end of the positive electrode terminal is electrically connected to the positive electrode current collector 12, and a second end of the positive electrode terminal penetrates the outer packaging body and is exposed to the exterior.

A first end of the negative electrode terminal is electrically connected to the negative electrode current collector 16, and a second end of the negative electrode terminal penetrates the outer packaging body and is exposed to the exterior.

### 1.7. Outer Packaging Body

The outer packaging body is constituted by a sheet-shaped member having a rectangular shape in planar view, and includes a first sheet and a second sheet, for example. The electrode body 11 is enveloped between the first sheet and the second sheet, and an outer circumferential edge portion of the first sheet and an outer circumferential edge portion of the second sheet are joined, so that sealing is performed. Accordingly, the outer packaging body has a bag shape, and envelops the electrode body 11 in the inside in a sealed manner.

Each of the first sheet and the second sheet can be constituted by a laminate film. The laminate film is a film that includes a metal layer and a sealant material layer. Examples of the metal that is used in the laminate film include aluminum and stainless steel, and examples of the material that is used in the sealant material layer include polypropylene, polyethylene, polystyrene, and polyvinyl chloride, which are thermoplastic resins.

### 2. Example

In examples, a test was performed while the kind and specific surface area of the conduction aid that was used in the positive electrode active material layer were varied.

### 2.1. Production of Electrode Body

### Production of Material for Positive Electrode Active Material Layer.

An elemental sulfur (S; vacuumed-dried at 80° C.) as a positive electrode active material, P₂S₅ as a sulfur-containing compound, and a carbon material (carbon materials different among examples were used as seen in Table 1; each carbon material was a carbon material vacuumed-dried at 120° C.) as a conduction aid were weighted such that the weight ratio (mass ratio) was 42:35:23, and the kneading of the raw materials was performed in an agate mortar for 15 minutes, so that a raw material mixture was obtained. Then, 1.7 g of the obtained raw material mixture was put in a container for a planetary ball mill. Furthermore, a zirconia ball having a diameter of 4 mm and a weight of 80 g was also added, and the container was sealed. The container was attached to a planetary ball mill machine (P7 manufactured by FRITSCH), and mechanical milling was performed at a rotation speed of 400 rpm for 36 hours. After the mechanical milling, dry classifying was performed using a 38-μm sieve, so that a material for a positive electrode active material layer was obtained.

### Production of Electrode Body

Further, 100 mg of particles (average particle diameter: 2.0 μm) of a sulfide solid electrolyte as a solid electrolyte was put in a die having a diameter of 11. 28 mm, and press was performed at 1 ton/cm², so that a solid electrolyte layer was shaped. Further, 7.6 mg of the above produced material for the positive electrode active material layer was laminated on a surface on one side of the shaped solid electrolyte layer, and press was performed at 1 ton/cm², so that a positive electrode active material layer was shaped.

An aluminum foil having a diameter of 11.28 mm was laminated on the positive electrode active material layer, and press was performed at 6 ton/cm², so that a positive electrode current collector layer was obtained.

On a surface on the other side of the solid electrolyte layer, an Li—Mg alloy foil (10 mass % Mg) having a diameter of 11.28 mm and a thickness of 100 μm was put, and furthermore, a roughened Ni foil was put. Then, press was performed at 1 ton/cm², so that a negative electrode active material layer (Li source) and a negative electrode current collector layer were shaped.

Finally, the obtained laminated body was confined at a confining pressure of 2 Nm (about 30 MPa), so that an electrode body was obtained.

### 2.2. Evaluation

A 60° C. constant-current charge-discharge test was performed to the electrode body in each example. Here, 1 C corresponds to 5.84 mA/cm².
(1) After a conditioning (discharge was performed at 0.1 C until the voltage became 1.2 V, and thereafter, a 10 minutes of break was performed), charge was performed at 0.1 C until the voltage became 3.1 V, 10 minutes of break was performed, discharge was performed at 0.1 C until the voltage became 1.2 V, and 10 minutes of break was performed. This was performed 3 cycles in total.
(2) Thereafter, a cycle in which charge was performed at 0.2 C until the voltage became 3.1 V, 10 minutes of break was performed, discharge was performed at 0.2 C until the voltage became 1.2 V, and 10 minutes of break was performed was performed 46 cycles in total (50 cycles including the conditioning and the 3 cycles in (1)). In the 2θth cycle and 40th cycle under the condition (2), charge was performed at 0.1 C until the voltage became 3.1 V, 10 minutes of break was performed, discharge was performed at 0.1 C until the voltage became 1.2 V, and 10 minutes of break was performed.

### 2.3. Result

FIG. 2 shows the relation between the cycle and the discharge capacity in each example. Table 1 shows the kind of the conduction aid, the BET specific surface area, the discharge capacity (“Initial Discharge Capacity” in Table 1) after the 3 cycles in the above (1), and the discharge capacity (“Final Discharge Capacity” in Table 1) after the 50 cycles in the above (2), for each example. In Table 1, the discharge capacity indicates a ratio with respect to the weight of the positive electrode active material layer.

TABLE 1

| | | | Initial | Final |
|---|---|---|---|---|
| | Kind of | BET Specific | Discharge | Discharge |
| | Conduction Aid | Surface Area | Capacity | Capacity |
| | Carbon Species | (m²/g) | (mAh/g) | (mAh/g) |
| Comparative | Vapor-grown | 17 | 865 | 757 |
| Example 1 | carbon fiber | | | |
| Comparative | Multi-walled | 148 | 635 | 14 |
| Example 2 | CNT | | | |
| Comparative | Multi-walled | 202 | 846 | 762 |
| Example 3 | CNT | | | |
| Example 1 | Multi-walled | 387 | 888 | 760 |
| | CNT | | | |
| Example 2 | Single-walled | 1188 | 940 | 861 |
| | CNT | | | |

As can be seen from the results, by using the single-walled and multi-walled CNT having a specific surface area of 400 m²/g or more as the conduction aid in the positive electrode containing the S element, both the initial discharge capacity and the final discharge capacity could be improved compared to the vapor-grown carbon fiber and the other CNTs. It can be said that the improvement was conspicuous, particularly, when the specific surface area was 1000 m²/g or more.

The reason is thought to be because electron conducting paths in the composite material containing the S element are amplified and in addition a self-formation reaction for Li⁺ conducting paths in the conditioning is promoted by using the single-walled and multi-walled CNT having a higher specific surface area than the vapor-grown carbon fiber as the conduction aid in the positive electrode active material layer. As a result, it is thought that the ratio of the sulfur active material that can be used in the positive electrode active material is increased and thereby both the discharge capacity and the cycle characteristic are improved.

What is claimed is:

1. A battery including an electrode body in which a positive electrode active material layer, an electrolyte layer, and a negative electrode active material layer are laminated, wherein:
the positive electrode active material layer contains a positive electrode active material and a carbon nanotube, the positive electrode active material containing an S element; and
a specific surface area of the carbon nanotube in the positive electrode active material layer is 400 m²/g or more.

2. The battery according to claim 1, wherein the specific surface area is 1000 m²/g or more.

3. The battery according to claim 1, wherein the positive electrode active material layer contains a sulfur-containing compound that contains the S element and a P element.

4. The battery according to claim 1, wherein the negative electrode active material layer contains an Li metal.

5. The battery according to claim 1, wherein the battery is an all-solid-state battery in which the electrolyte layer contains a solid electrolyte.
